(19) United States
(12) Patent Application Publication
(10) Pub. No.: US 2016/0166456 A1
(43) Pub. Date: Jun. 16, 2016

(54) TORSO LIFT DEVICE

(71) Applicants: Hamid Ayub, Plantation, FL (US); Mikael A. Ayub, Plantation, FL (US)

(72) Inventors: Hamid Ayub, Plantation, FL (US); Mikael A. Ayub, Plantation, FL (US)

(21) Appl. No.: 14/969,771

(22) Filed: Dec. 15, 2015

Related U.S. Application Data
(60) Provisional application No. 62/181,238, filed on Jun. 18, 2015.
(60) Provisional application No. 62/092,417, filed on Dec. 16, 2014.

(51) Int. Cl. A61G 13/12; A47C 20/00

(52) U.S. Cl. CPC A61G 13/123; A47C 20/00

(57) ABSTRACT

A lift device for elevating a buttocks of a person above a support surface includes an inflatable cushion having a top end and a bottom end, a rear panel configured to be disposed on the support surface, a first side panel and a second side panel, extending upwardly from opposite side edges of the rear panel, and a front panel extending between the first and second side panels, the front panel extending upwardly from the rear panel at the top end of the inflatable cushion toward the bottom end of the inflatable cushion so that the bottom end of the inflatable cushion has a greater height relative to the support surface than does the top end of the inflatable cushion, wherein the bottom end of the inflatable cushion is disposed adjacent the buttocks of the person and the top end of the inflatable cushion is disposed between the buttocks and head of the person.

### CLAIM OF PRIORITY

This application claims priority to U.S. Provisional Application No. 62/181,238 filed Jun. 18, 2015, and U.S. Provisional Application No. 62/092,417, filed Dec. 16, 2014, of which the entire disclosures are incorporated herein.

### FIELD OF THE INVENTION

The present disclosure relates generally to medical assistance devices for bedridden patients and, more specifically, to a lifting device to assist in positioning a patient's lower torso for hygienic care.

### BACKGROUND

Products to assist in the process of changing the undergarments, diaper, etc. of an adult patient or bedridden person have primarily focused on accessories such as wipes, disinfectants, undergarments. However, these accessories do not typically assist the caregiver in more easily changing the diaper and accessing contaminated areas of the bedridden person for easier cleaning.

Due to difficulty in handling, especially lifting the adult patient or bedridden person, to change their diapers, the risk of inadequate cleaning and changing of an adult patient or bedridden person is high, along with the risk of exposure to potentially contaminated substances, such as human waste. Human waste is full of bacteria and other microorganisms that can be potentially dangerous. Also, as human waste is generally repugnant, the caretaker may try to avoid contact, while also facing the difficulty of handling the adult patient or bedridden person at the same time. This could result in improper cleaning.

For the caregiver, the process of changing the diaper of a bedridden patient can be a challenge. Changing the diaper for such a person involves lifting the person's lower torso (buttocks) high enough to remove the soiled diaper and replace it with clean one. Often, the diaper wearer must also be cleaned, and powder, ointment, petroleum jelly, etc., may also be applied. All this has to be done while the diaper wearer's lower torso (buttocks) is above the support surface, i.e., bed, stretcher, etc., he is resting on. This can be difficult for the caregiver and often cannot be easily done by a single person. Also, there is the sanitary risk of contamination and danger of injury to both diaper wearer and caregiver.

The present invention recognizes and addresses considerations of prior art constructions and methods.

### SUMMARY OF INVENTION

An embodiment of a lift device for elevating a buttocks of a person above a support surface includes an inflatable cushion having a top end and a bottom end, a rear panel configured to be disposed on the support surface, a first side panel and a second side panel, the first and second side panels extending upwardly from opposite side edges of the rear panel, and a front panel extending between the first and second side panels, the front panel extending upwardly from the rear panel at the top end of the inflatable cushion toward the bottom end of the inflatable cushion so that the bottom end of the inflatable cushion has a greater height relative to the support surface than does the top end of the inflatable cushion, wherein the bottom end of the inflatable cushion is disposed adjacent the buttocks of the person and the top end of the inflatable cushion is disposed between the buttocks and head of the person so that the buttocks are elevated above the support surface when the inflatable cushion is in an inflated state.

Another embodiment of a lift device elevating a buttocks of a person above a support surface includes a panel having a top edge and a bottom edge, the panel being pivotably secured to the support surface at its top edge, wherein the bottom edge of the panel is pivotable upwardly away from the support surface so that the buttocks of the person disposed on the support surface is elevated above the support surface.

The accompanying drawings, which are incorporated in and constitute a part of this specification, illustrate one or more embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended drawings, in which:

FIG. 1 is a perspective view of a first embodiment of a torso lift device in accordance with the present disclosure;

FIG. 2 is a front view of a second embodiment of a torso lift device in accordance with the present invention;

FIG. 3 is a right side view of the torso lift device shown in FIG. 2;

FIG. 4 is a top view of the torso lift device shown in FIG. 2;

FIG. 5 is a bottom view of the torso lift device shown in FIG. 2;

FIG. 6 is a top view of the torso lift device shown in FIG. 2, in the deflated state;

FIGS. 7A, 7B and 7C are perspective views of a third embodiment of a torso lift device in accordance with the present disclosure;

FIGS. 8A and 8B are side views of the torso lift device shown in FIG. 7A in the stored position and deployed position, respectively; and

FIGS. 9A and 9B are side views of a torso lift device similar to the one shown in FIG. 1, incorporated in a mattress of a bedridden patient.

Repeat use of reference characters in the present specification and drawings is intended to represent same or analogous features or elements of the invention according to the disclosure.

### BRIEF DESCRIPTION OF USE

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

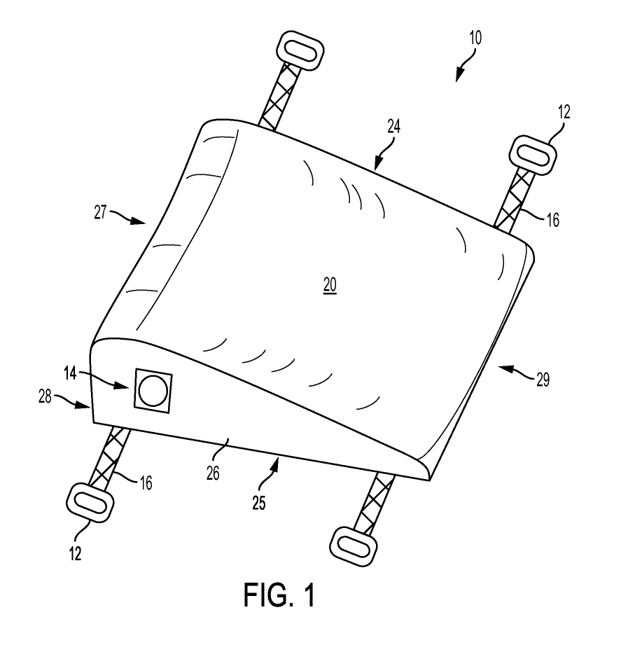

Referring now to the figures, various embodiments of torso lift devices in accordance with the present disclosure are shown. Specifically, an inflatable torso lift cushion 10 is shown in FIG. 1, including two pairs of assist handles 12, one on each side of the inflatable cushion, and an inflation/deflation valve 14 provided in one, or both, of the cushion's sidewalls. Inflatable cushion 10 includes a front panel 20 disposed opposite a rear panel 25, the front and rear panels extending between a pair of opposed left and right side panels 24 and 26. Preferably, left and right side panels 24 and 26 extend upwardly beyond the central portion of front panel 20, as is evidenced by the concave nature of front panel 20. As such, when a bedridden patient's torso is elevated with the inflatable cushion, the patient will remain centered on the cushion. As well, the elevated side panels 24 and 26 help to insure the patient will not roll off of the cushion as the caregiver manipulates the patient. As well, referring additionally to FIG. 9B, when the cushion is inflated to support a patient, as discussed in greater detail below, front panel 20 extends downwardly from the top of a bottom end panel 28 to the top end 29 of the cushion. This allows the patient's buttocks to be elevated above the corresponding support surface, whereas the patient's upper torso and shoulders remain relatively in place.

As shown in FIG. 1, inflation/deflation valve 14 is disposed in right side panel 26 of the inflatable cushion. However, as noted above, valve 14 may also be disposed in left side panel 24, or a valve may be provided in both side panels. Some example valves 14 for use in inflatable cushion 10 include, but are not limited to, a “Boston valve,” available from KWIK TEK, INC., Denver, Colo., and an “easy inflate and deflate valve,” available from Halkey-Roberts Corporation, Saint Petersburg, Fla. These types of valves allow for inflation and deflation by pumps 80 (FIG. 9B) that are available off-the-shelf from Coleman, Wichita, Kans., and Overton's, Greenville, N.C. Preferably, assist handles 12 are connected to inflatable cushion 10 by handle straps 16 constructed of a material such as Nylon.

The inflatable torso cushion shown in FIG. 1 is used as follows. When a soiled undergarment, such as a diaper, needs to be changed, inflatable cushion 10 is pulled under the bedridden patient by the use of handles 12 and positioned under the lower torso without any part of the inflatable cushion being disposed under the buttocks. In a case in which inflatable cushion 10 is already installed on a bed, which is the case in FIG. 9A, the patient is moved to a position in which no part of the inflatable cushion is under the patient's buttocks. The inflatable cushion is then inflated, as shown in FIG. 9B, to lift the bedridden patient, exposing/suspending his buttocks a few inches in the air. The caregiver can now easily change the diaper and/or apply powder, ointment, petroleum jelly, etc. Once the patient is clean, a new diaper can be put on. On successfully putting on the new diaper, the inflatable cushion can be deflated to a flat position (see FIG. 6). In those instances in which inflatable torso cushion 10 is not installed on the bed, it can be pulled out from under the person.

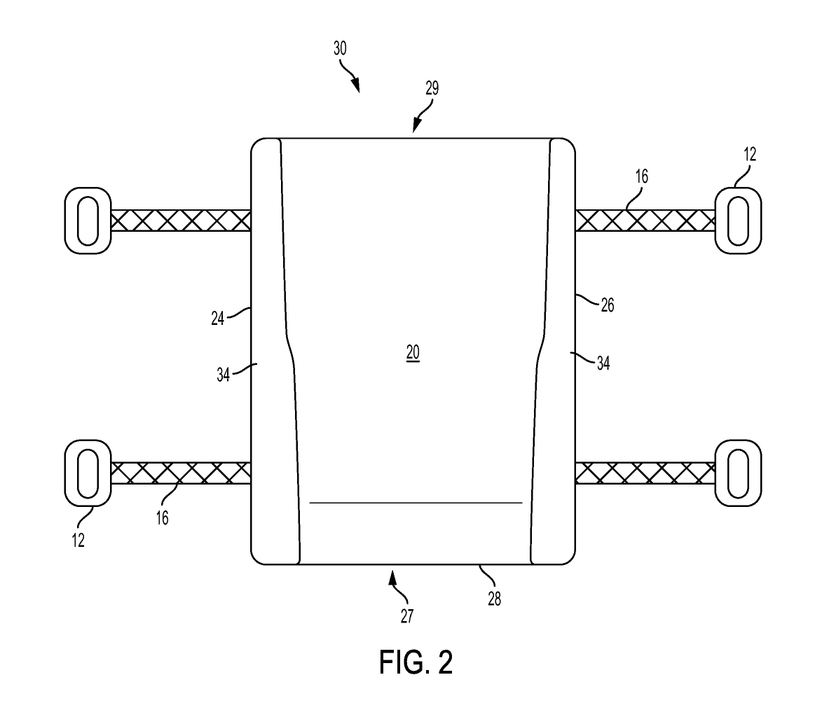

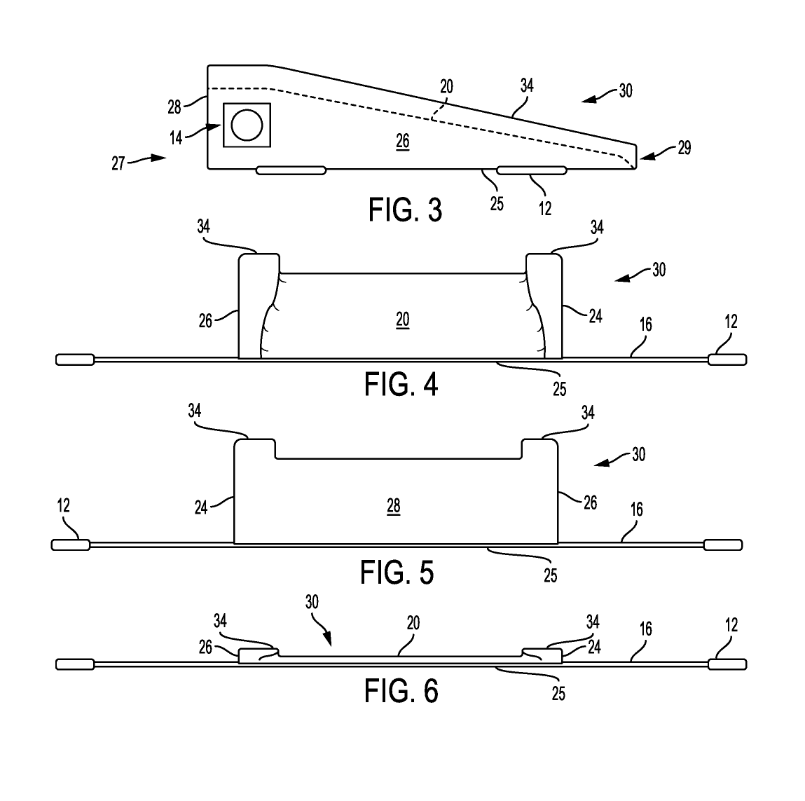

Referring now to FIGS. 2 through 6, an alternate embodiment of an inflatable torso lift cushion 30 is shown. Inflatable cushion 30 is substantially similar to the previously discussed embodiment shown in FIG. 1 with the exception that a side bolster 34 is provided along each side edge of front panel 20. As best seen in FIGS. 4 and 5, each side bolster 34 extends upwardly from a corresponding side edge of front panel 20. As such, side bolsters 34 help to keep the bedridden patient centered on inflatable cushion 30 and prevent the patient from rolling off. As shown in FIG. 3, each side bolster 34 extends along the full length of front panel 20. Additionally, the side bolsters are spaced farther apart at top end 29 of inflatable cushion 30 than they are at bottom end 27 of the cushion as patients' upper torsos are typically wider than their lower torsos. FIG. 6 shows inflatable cushion 30 in the deflated state which facilitates placement of the cushion under the patient.

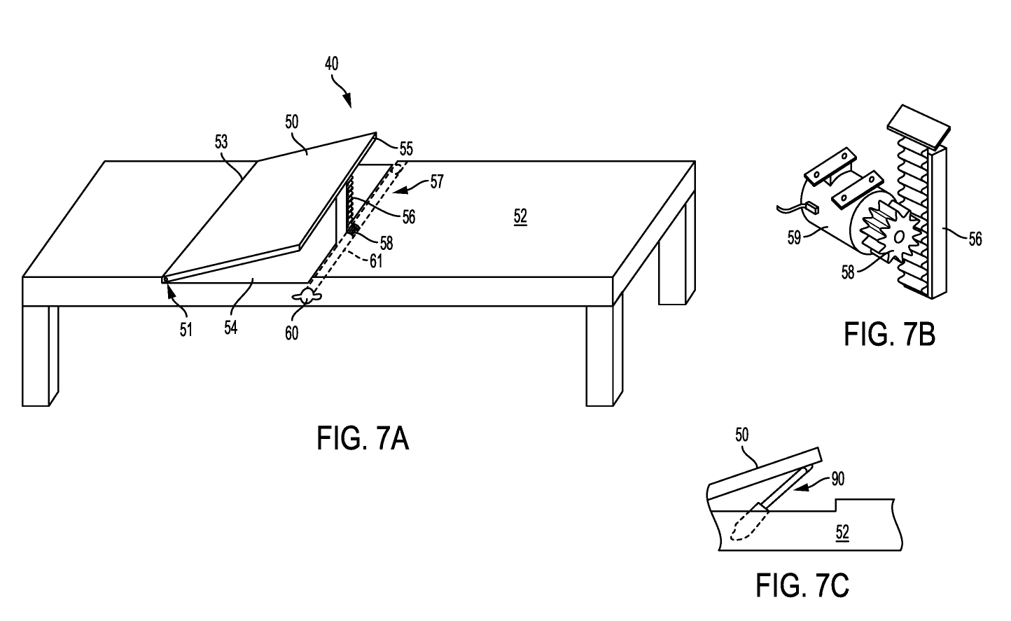

Referring now to FIG. 7A, an alternate embodiment of a torso lift device 40 in accordance with the present disclosure is shown. Torso lift device 40 includes a panel 50 that is pivotable relative to the patient's support surface, in the present case a bed 52. Panel 50 is pivotably secured to bed 52 at its top edge 53 about a pivot axis 51, and is secured to bed 52 at its bottom edge 55 by a rack and pinion assembly 57. The assembly includes a vertical rack 56 that is selectively driven by a pinion 58 formed on pinion bar 61. A handle 60 is provided at each end of pinion bar 61 to allow the caregiver to raise and lower the patient's lower torso, and therefore buttocks, from either side of bed 52. Note, although only one rack and pinion assembly is shown, two or more may be used to raise panel 50.

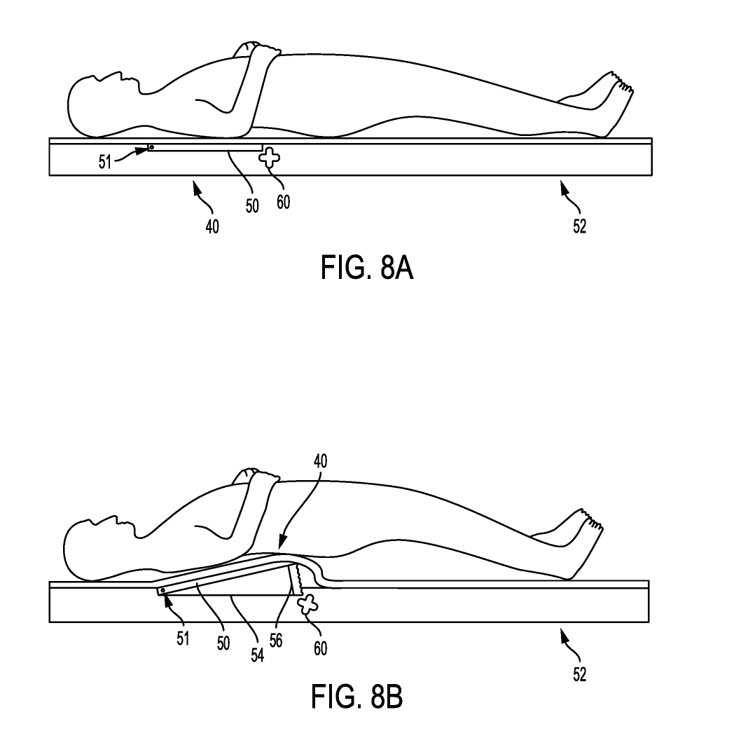

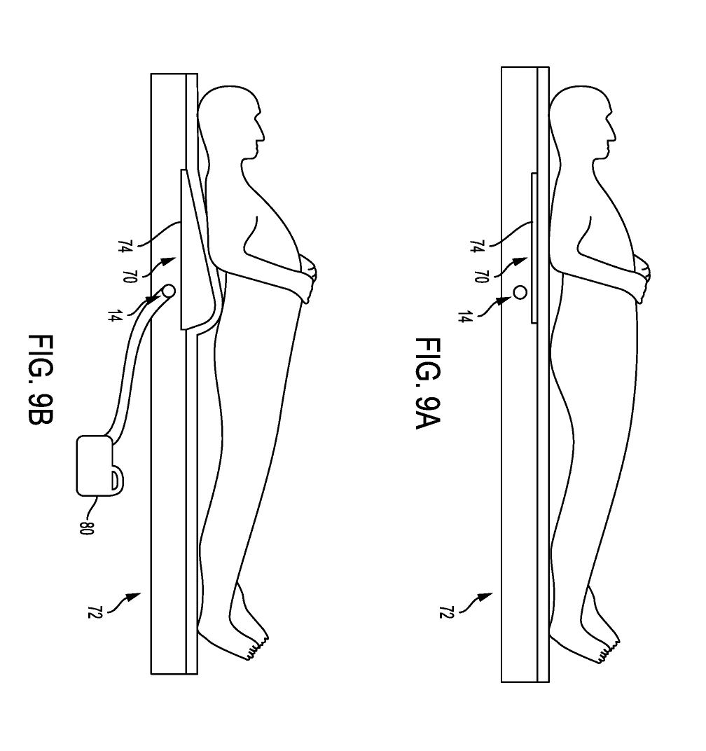

Referring additionally to FIGS. 8A and 8B, when panel 50 is not extended, it is recovered in a recess 54 in the top surface of bed 50. Recess 54 may be formed in either a hard support surface, such as most examining tables, or in a mattress of a typical bed. As such, the top of panel 50 is substantially flush with the top surface of the bed when not in use. When it is desired to lift the patient's buttocks above the support surface, the caregiver simply aligns bottom edge 55 of panel 50 with the desired portion of the patient's lower torso and rotates pinion bar 61 with handle 60 as necessary. To lower the panel, pinion bar 61 is simply rotated in the opposite direction. As shown in FIG. 7B, rather than a manually operated assembly, an electric motor 59 driven pinion 58 may be used to facilitate raising and lowering the panel. As shown in FIG. 7C, in alternate embodiments, one or more hydraulic or pneumatic pistons 90 may be used to raise and lower the bottom edge 55 of panel 50.

Referring now to FIGS. 9A and 9B, yet another embodiment of a torso lift device is shown. Specifically, torso lift device 70 includes an inflatable torso lift cushion 74, substantially similar to the embodiments shown in FIG. 1 and FIGS. 2 through 6, incorporated into the upper surface of a mattress 72 of a bed. As such, torso lift cushion 74 is always positioned underneath the bedridden patient for use when needed. As previously noted, a pump 80 is used to inflate and deflate inflatable torso lift cushion 74 by way of a valve 14.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents. The illustrative drawings and descriptions stated herein may be modified without departing from the basic concept. This could be dimensions to accommodate various bed sizes and/or the adult or bedridden patient weight and height.

What is claimed:

1. A lift device for elevating a buttocks of a person above a support surface, comprising:
an inflatable cushion having a top end and a bottom end, comprising:
a rear panel configured to be disposed on the support surface;
a first side panel and a second side panel, the first and second side panels extending upwardly from opposite side edges of the rear panel; and
a front panel extending between the first and second side panels, the front panel extending upwardly from the rear panel at the top end of the inflatable cushion toward the bottom end of the inflatable cushion so that the bottom end of the inflatable cushion has a greater height relative to the support surface than does the top end of the inflatable cushion;
wherein the bottom end of the inflatable cushion is disposed adjacent the buttocks of the person and the top end of the inflatable cushion is disposed between the buttocks and head of the person so that the buttocks are elevated above the support surface when the inflatable cushion is in an inflated state.

2. The lift device of claim 1, further comprising a bottom end panel extending upwardly from the rear panel to the top panel, and extending between the first and second panels.

3. The lift device of claim 1, further comprising a valve disposed in one of the first and second sidewalls, the valve being configured to selectively retain air within the inflatable cushion.

4. The lift device of claim 3, further comprising at least one handle extending outwardly from a first side of the inflatable cushion.

5. The lift device of claim 4, wherein the at least one handle further comprises a first and a second handle, the first and second handles extending outwardly from opposite sides of the inflatable cushion.

6. The lift device of claim 5, wherein each of the first and second handles is connected to the inflatable cushion by a flexible strap.

7. The lift device of claim 1, wherein the front panel defines a concave surface extending along a longitudinal axis of the inflatable cushion when in an inflated state.

8. The lift device of claim 1, wherein an upper edge of each of the first and second side panels extends upwardly from the support surface to a greater extent than does the front panel.

9. The lift device of claim 1, wherein a side bolster extends upwardly from each side edge of the front panel.

10. The lift device of claim 1, wherein the support surface further comprises an upper surface of a mattress, and the inflatable cushion is disposed on the upper surface of the mattress.

11. The lift device of claim 10, wherein the upper surface of the mattress defines a recess, the inflatable cushion being disposed within the recess.

12. A lift device for elevating a buttocks of a person above a support surface, comprising:
a panel having a top edge and a bottom edge, the panel being pivotably secured to the support surface at the top edge of the panel;
wherein the bottom edge of the panel is pivotable upwardly away from the support surface so that the buttocks of the person disposed on the support surface is elevated above the support surface.

13. The lift device of claim 12, further comprising a lift assembly for selectively pivoting the bottom edge of the panel upwardly away from the support surface.

14. The lift device of claim 13, wherein the lift assembly comprises a rack and pinion assembly, the rack extending between the panel and the support surface and the pinion being rotatably secured to the support surface.

15. The lift device of claim 13, wherein the lift assembly comprises at least one of a pneumatic piston and a hydraulic piston.

16. The lift device of claim 12, wherein the support surface comprises an upper surface of a mattress.

17. The lift device of claim 12, wherein the support system comprises an upper surface of an examination table.
